SEQUENCE LISTING (2 sequences)

SEQ ID NO: 1 - DNA, 17 bp, Artificial Sequence
  V2 Forward
ggcgaacgggtgagtaa

SEQ ID NO: 2 - DNA, 17 bp, Artificial Sequence
  V2 Reverse
actgctgcctcccgtag

(19) United States
(12) Patent Application Publication
(10) Pub. No.: US 2012/0181175 A1
(43) Pub. Date: Jul. 19, 2012

(54) FILLER FOR ANALYZING CAPILLARY ELECTROPHORESIS-BASED SINGLE STRAND CONFORMATION POLYMORPHISM, AND METHOD FOR USING THE FILLER FOR ANALYZING CAPILLARY ELECTROPHORESIS-BASED SINGLE STRAND CONFORMATION POLYMORPHISM

(75) Inventors: Hyun Kee Kim, Daegu (KR); Gyoo Yeol Jung, Pohang-si (KR); Gi Won Shin, Pohang-si (KR); Hee Sung Hwang, Pohang-si (KR)

(73) Assignee: THE BIO CO., LTD, Pohang-si, Gyeongsangbuk-do (KR)

(21) Appl. No.: 13/498,496

(22) PCT Filed: Oct. 9, 2009
(86) PCT No.: PCT/KR2009/005809

§ 371 Date: Mar. 27, 2012

(30) Foreign Application Priority Data
Sep. 29, 2009 (KR) 10-2009-0092170

(51) Int. Cl. G01N 27/26; B01D 43/00

(52) U.S. Cl. 204/451; 252/408.1

(57) ABSTRACT

The present invention relates to filler for analyzing capillary electrophoresis-based single strand conformation polymorphism, and to a method for using the filler for analyzing capillary electrophoresis-based single strand conformation polymorphism, and more particularly, to filler for analyzing capillary electrophoresis-based single strand conformation polymorphism, the filler containing a polymer micelle formed by dispersing a sandwich-block copolymer comprising (Hydrophilic group)-(Hydrophobic group)-(Hydrophilic group) in an aqueous medium, and to a method for using the filler for analyzing capillary electrophoresis-based single strand conformation polymorphism.

### FIELD OF THE INVENTION

The present invention relates to filler for analyzing capillary electrophoresis-based single strand conformation polymorphism and a method for analyzing capillary electrophoresis-based single strand conformation polymorphism using the same.

### BACKGROUND OF THE INVENTION

In general, a method for indentifying a living thing or disease by gene availability has been used for a long time (Journal of Clinical Microbiology 1996 January; 34(1):130-133). In this case, the living thing or disease is treated with different drugs according to a kind of the living thing or disease, and in this case, new varieties are developed and sometimes the existing drug can't treat it. Most of the varieties are produced by mutation. In order to analyze these varieties including mutation, the necessity of quick and accurate separation of nucleic acids, particularly, deoxyribonucleic acids (DNA) in polymerase chain reaction (PCR) product analysis and DNA sequencing fragment analysis is emerging (for example, see [Williams, Methods 4: 227-232 (1992)], [Drossman et al., Anal. Chem., 62: 900-903 (1990)], [Huang et al., Anal. Chem., 64: 2149-2154 (1992)] and [Swerdlow et al., Nucleic Acids Research, 18: 1415-1419 (1990)]).

Conventionally, in order to search mutation such as base substitution, insertion and deletion existing on base sequence of DNA, dot blotting method, RFLP (Restriction Fragment-Length Polymorphism), SSCP (Single-Strand Conformational Polymorphism) or sequencing method analyzing base sequence of DNA have been used.

Among these methods, first, the dot blotting method (British Journal of Dermatology 1994 July; 131(1):72-77) uses a principle of southern method, namely, a character that even if only one base sequence is different, DNAs are not bound each other at over certain temperature, and processed by attaching DNA to a membrane, and a radioactive material, fluorescent material or enzyme used for color reaction is bound to oligonucleotide, which is desired to confirm and made up of a certain-sized base sequence, followed by confirming whether there is a mutation depending on signal. Further, the oligonucleotide is linked to a membrane and DNA is amplified to confirm whether they are bound each other or not. Second, RFLP (Restricton fragment length polymorphism) (Molecular Cell Biology 1995: 279-281) method uses a character that a restriction enzyme can cut a certain base sequence only. When DNA base sequence amplified by PCR is treated with a restriction enzyme, if there is a mutation on a cleavage site of the restriction enzyme, the sequence would not be cut. Thus, when a normal DNA sequence and a DNA sequence having mutation on a restriction enzyme cleavage site are cut with the same restriction enzyme, the normal sequence is cleaved but the sequence having mutation thereon is not cleaved. After treating the restriction enzyme as described above, when both DNA are electrophoresed on the same gel, the electrophoresis band numbers of the normal DNA and the DNA having mutation are different each other. Namely, this is a method to compare and confirm shapes of DNA electrophoresis on a gel. Third, SSCP (single strand conformation polymorphism) method (Molecular Cell Biology 1995: 289) was first developed by Orita et al (Orita, M., et al., Proc Natl Acad Sci USA 1989; 86:2766-70), and it is one of the most frequently and multipurposely used economical methods for gene screening. Unlike other genotype analysis methods, SSCP does not provide accurate information about a unique position of base sequence, but can measure a state of gene mutation by comparing with a control group.

SSCP (Single strand conformation polymorphism) uses a principle that a change induced by mutation on DNA nucleotide sequence makes a change on structural folding of a single strand DNA, and makes a difference in migration distance of electrophoresis. Namely, it uses a principle that bases (A, T, C and G) constituting DNA are differently dragged by electricity, respectively. Methodically, when PCR products of a normal DNA and a mutated DNA are denatured at high temperature and immediately cooled, DNAs forms unique secondary structures according to their base sequences, respectively, and differences in their structures is examined by electrophoresis. Namely, when DNA, which is once formed to single strand and reannealed, is electrophoresed, even only one base change makes a difference. Therefore, this method is to compare DNA pattern shown in the electrophoresed gel with normal DNA pattern and confirm thereof. Traditionally, SSCP is measured by electrophoresing DNA labeled with a radioactive isotope in a medium having high resolution such as 20% acrylamide slab-gel, and this method has problems that it takes long time (about 14 hours), it is labor-intensive, its result completely depends on the performer's skill, and it can be only selectively and restrictively applied to clinical medicine (Kourkine, I. V., et al., Electrophoresis 2002; 23:1375-85).

The recently developed capillary electrophoresis, which uses a micro tube fused silica capillary having inside diameter of 50-75 μm became an practical alternative measure of the slab-gel SSCP. The capillary electrophoresis (hereinafter, called “CE”) is a analysis method broadly used due to its several technical benefits, and namely, the technical benefits are as follows: (i) the capillary containing a medium for separation has high surface to volume ratio, effectively emits heat, and then makes a high-voltage field be used for rapid separation; (ii) the minimum sample volume is needed; (iii) excellent resolution can be obtained; and (iv) the method can be easily automated (for example, see [Camilleri, Ed., Capillary Electrophoresis: Theory and Practice (CRC Press, Boca Raton, 1993)] and [Grossman et al., Eds., Capillary Electrophoresis (Academic Press, San Diego, 1992)]). Due to these benefits, it has been focused on being applied to separate biomolecules, or analyzing single strand conformation polymorphism using thereof.

As a polymer filling the capillary of the capillary electrophoresis (CE), linear polyacrylamide (LPA) gel, polyethyleneoxide gel, poly(N,N-dimethylacrylamide) (PDMA) gel, methyl cellulose (MC), native silica and the like have been conventionally used, and now, poly(N,N-dimethylacrylamide) (PDMA) is being mainly used.

When the conventional poly(N,N-dimethylacrylamide) (PDMA) and conventional polymers are used, they react with DNA or DNA-labeling dyes due to hydrophobic character of these polymers, and it causes broadening a peak. Therefore, a composition comprising a polymer and copolymer effective on the capillary electrophoresis, and a polymer useful for the said separation is still needed.

### SUMMARY OF THE INVENTION

Accordingly, it is an object of the present invention to provide filler for analyzing capillary electrophoresis-based single strand conformation polymorphism, which can quickly and accurately separate biomolecules, and a method for analyzing capillary electrophoresis-based single strand conformation polymorphism using the same.

In order to solve the said problems, the present invention provides filler for analyzing capillary electrophoresis-based single strand conformation polymorphism comprising a polymer micelle, which is formed by dispersing a triblock copolymer indicated as (Hydrophilic group)-(Hydrophobic group)-(Hydrophilic group) in an aqueous medium.

Further, the present invention provides the filler for analyzing capillary electrophoresis-based single strand conformation polymorphism, wherein the hydrophilic group content of the triblock copolymer indicated as (Hydrophilic group)-(Hydrophobic group)-(Hydrophilic group) is 70 to 85%, and the number-average molecular weight thereof is 10,000 Da or more.

Further, the present invention provides the filler for analyzing capillary electrophoresis-based single strand conformation polymorphism, wherein the triblock copolymer indicated as (Hydrophilic group)-(Hydrophobic group)-(Hydrophilic group) forms the micelle by being dispersed in an aqueous medium to the concentration of 11 wt % to 16 wt % to make the viscosity of the aqueous medium 10⁵ to 10⁶, which is suitable to form the micelle.

Further, the present invention provides the filler for analyzing capillary electrophoresis-based single strand conformation polymorphism, which comprises the polymer micelle formed by dispersing a PEO-PPO-PEO triblock copolymer as the triblock copolymer indicated as (Hydrophilic group)-(Hydrophobic group)-(Hydrophilic group) in an aqueous medium.

Further, the present invention provides a method for analyzing capillary electrophoresis-based single strand conformation polymorphism, wherein a sample containing a polymer is electrophoresed in the presence of the filler for analyzing capillary electrophoresis-based single strand conformation polymorphism.

The present invention provides the method for analyzing capillary electrophoresis-based single strand conformation polymorphism, wherein the polymer used in the method is a single strand and a gene, and it contains gen variations such as SNP (Single nucleotide polymorphism) and CNV (copy number variant).

### ADVANTAGEOUS EFFECTS OF THE INVENTION

The filler for analyzing capillary electrophoresis-based single strand conformation polymorphism of the present invention is composed of a hydrophobic group and a hydrophilic group. Therefore, it can improve the resolution by reducing the reaction of the hydrophobic group with DNA by forming a micelle structure.

### BRIEF DESCRIPTION OF THE DRAWINGS

The above and other objects and features of the present invention will become apparent from the following description of the invention taken in conjunction with the following accompanying drawings, which respectively show:

FIG. 1: a result of electrophoresis according to Example 1 of the present invention.

FIG. 2: a diagram representing the resolution to each concentration of copolymers used in Example 1 of the present invention.

FIG. 3: a diagram representing a result of electrophoresis according to Example 2 of the present invention.

FIG. 4: a diagram representing a result of electrophoresis according to Example 3 of the present invention.

FIG. 5: a diagram representing the resolution to each concentration of copolymers used in Example 3 of the present invention.

FIG. 6: a diagram representing a result of electrophoresis according to Comparative Example of the present invention.

FIGS. 7 to 9: diagrams representing the resolution in Comparative Example of the present invention.

FIG. 10: a diagram comparing results of electrophoresis according to Example 3 and Comparative Example of the present invention.

### DETAILED DESCRIPTION OF THE INVENTION

Hereinafter, the present invention will be described in detail

The filler for analyzing capillary electrophoresis-based single strand conformation polymorphism of the present invention comprises a polymer micelle formed by dispersing a triblock copolymer indicated as (Hydrophilic group)-(Hydrophobic group)-(Hydrophilic group) in an aqueous medium.

The filler for analyzing capillary electrophoresis-based single strand conformation polymorphism of the present invention is characterized by being composed of a hydrophobic group and a hydrophilic group, and forming a micelle structure, wherein the hydrophilic group surrounds the hydrophobic group in the aqueous medium. The filler for analyzing capillary electrophoresis-based single strand conformation polymorphism can maintain the shape stability by forming the micelle structure, wherein the hydrophilic group surrounds the hydrophobic group, as well as it can have excellent resolution by preventing the hydrophobic group from interacting with DNA.

In the present invention, the triblock copolymer indicated as (Hydrophilic group)-(Hydrophobic group)-(Hydrophilic group) can be any copolymer, which forms a polymer micelle in an aqueous medium, regardless of a kind of polymers making up of each group.

The polymer composing the hydrophilic group may be polyethylene oxide (polyethyleneglycol), polyvinylalcohol, poly(meth)acrylate, polyvinylpyridine, polyacrylamide, polydimethylacrylamide and polymethylvinylether, and the polymer composing the hydrophobic group may be polypropylene oxide, polyglycolide, poly(butyrolactone), poly(valerolactone), polypropylene glycol, poly(α-amino acid), poly(methyl methacrylate), poly(ethyl methacrylate), polystylene, poly(α-methylstylene), polyisoprene, polybutadiene, polyethylene, polypropylene and polyvinylacetate, but not limited thereto.

The particularly preferred hydrophilic group of these is polyethyleneoxide in view of the micelle forming ability. Further, the particularly preferred hydrophobic group is polypropyleneoxide in view of the micelle forming ability.

The particularly preferred inventive triblock copolymer indicated as (Hydrophilic group)-(Hydrophobic group)-(Hydrophilic group) is PEO-PPO-PEO in view of the micelle forming ability.

Polyethyleneoxide-polypropyleneoxide-polyethyleneoxide (PEO-PPO-PEO) polymer is water-soluble and amphiphilic polymer, and it is characterized that sol-gel phase transition occurs in an aqueous solution according to the temperature change at over certain concentration. The PEO-PPO-PEO polymer is a triblock copolymer, wherein both ends of the hydrophobic polypropyleneoxide moiety in a middle are connected to each hydrophilic polyethyleneoxide moieties, respectively. And it forms the micelle structure by itself in an aqueous medium resulting from hydrophobic interaction between polypropyleneoxide moieties, and when the temperature rise, water molecules are excluded and the force caused by the hydrophobic interaction increases.

The polyethylene oxide-polypropylene oxide-polyethylene oxide polymer has been broadly studied for the past ten years, and is being provided as a brand name of Pluronic or Poloxamer according to various molecular weights and hydrophilic/lypophilic balance (HLB).

The triblock copolymer of the present invention may be prepared by any method already known in the art, and preferably, it can be prepared by subjecting living anionic polymerization using each corresponding monomers to form a hydrophilic group, and polymerizing monomers corresponding to a hydrophobic group thereto followed by introducing the hydrophilic group again. This polymerization method is suitable for preparing a triblock copolymer, wherein each group has desired molecular weight.

Specifically, the triblock copolymer of the present invention may have the hydrophilic group content of 70 to 85%, and the number-average molecular weight of 10,000 Da or more, preferably. Further, molecular weight of each group can be measured by gel permeation chromatography.

The triblock copolymer indicated as (Hydrophilic group)-(Hydrophobic group)-(Hydrophilic group) prepared as described above can be synthesized to a powder form, and a polymer micelle can be formed by dispersing the powder in an aqueous medium (for example, water or aqueous solution buffered with a proper buffer) to the certain concentration enough to form a micelle, and therefore, a “matrix” can be formed.

In the present invention, the triblock copolymer indicated as (Hydrophilic group)-(Hydrophobic group)-(Hydrophilic group) is dispersed in an aqueous medium to the concentration enough to form the micelle structure. And, in the present invention, it is preferred that the triblock copolymer indicated as (Hydrophilic group)-(Hydrophobic group)-(Hydrophilic group) is dispersed in an aqueous medium to the concentration of 11 wt % to 16 wt % to have viscosity in the range from 10⁵ to 10⁶ to form a micelle, which is suitable for separating polymers in the range from 200 bp to 500 bp.

The proper aqueous medium in which the triblock copolymer indicated as (Hydrophilic group)-(Hydrophobic group)-(Hydrophilic group) is dispersed to form the micelle structure may be an aqueous medium generally used to filler for electrophoresis, for example, DMSO (Dimethyl sulfoxide), ethanol, EDTA (Ethylenediaminetetraacetic acid) and the like.

The capillary electrophoresis using the filler for capillary electrophoresis is to electrophorese a sample containing a polymer in the presence of the filler for electrophoresis, but not limited thereto. A device for performing the capillary electrophoresis is well known. Several CE devices, for example, the Applied Biosystems Inc. (ABI, Foster City, Calif.) model 310 Genetic Analyzer, models 3700 and 3730 DNA Analyzer, and the ABI PRISM® 3100 Genetic Analyzer are commercially usable. Exemplary references explaining the CE devices and operations thereof includes [Colburn et al., Applied Biosystems Research News, Issue 1 (Winter 1990)]; [Grossman et al., Eds., Capillary Electrophoresis (Academic Press, San Diego, 1992)]; [Harrison et al., Science, 261: 895-897 (1993)]; [Pace, U.S. Pat. No. 4,908,112]; [Kambara et al., U.S. Pat. No. 5,192,412]; and [Seiler et al., Anal. Chem., 65: 1481-1488 (1993)].

The polymer, which is separated using the filler for capillary electrophoresis of the present invention may be protein, peptide, amino acid, saccharide, polysaccharide, nucleic acid (for example, DNA, RNA and the like) and the like. The nucleic acid may be a single strand or double strand. This polymer may be 16S rRNA (ribosomal RNA) gene, EF-2 (translation elongation factor2), IF-3 (translation initiation factor 3), IF-2 (translation initiation factor 2) and the like, and the 16S rRNA gene is preferred. The 16S rRNA is a rRNA existing in a ribosomal small subunit of prokaryote such as, and the 16S rRNA gene coding thereof is generally used for identification and classification of microorganisms because it has both a conserved region, which has the size of around 1,500 bp and is identically found in entire prokaryotes, and a variable region, which is specifically found on subspecies level. The polymer can be separated and amplified by various methods known in the art.

A fluorescent reagent for detecting the nucleic acid may be Ethidium bromide [510/595 (excitation wavelength/emission wavelength, hereinafter, the rest is the same)], Ethidium homodimer-1 [528/617], Acridine orange [502/526], Thiazole orange (TO) [509/525], YO-PRO-1 [491/509], YO-PRO-3 [612/631], TO-PRO-1 [515/531], TO-PRO-3 [642/661], YO-YO-1 [491/509], TO-TO-1 [514/533], YO-YO-3 [612/631], TO-TO-3 [642/660], SYBR Green I) [494/521], SYBR green [254/520], SYBR Gold [300, 495/537], Oli Green (for ssDNA) [500/520], Ribo Green (for RNA) [500/525], FITC [494/519], 6-FAM [488/535], HEX [515/559], cy5 [649/670], cy3 [550/570] and the like.

Because the filler for analyzing capillary electrophoresis-based single strand conformation polymorphism of the present invention can quickly obtain high resolution, it is useful for gene analysis, PCR analysis, cancer gene diagnosis analysis, SNPs analysis by SSCP, VNTR analysis, PCR-RFLP analysis, microsatellite analysis, other application for analysis of various diseases such as dementia, muscular dystrophy, heart disease, myocardial infarction, Down's syndrome, infectious disease, diabetes, phenylketonuria and the like, and high throughput screening analysis of protein or sugar chain in proteasome analysis or glycosome analysis, and the inventive filler for analyzing capillary electrophoresis can be used for analyzing a single strand nucleic acid, particularly to SSCP method.

For SSCP electrophoresis, PCR product is heated to 90-98° C., preferably 94° C. for 4 min for denaturation and immediately cooled on ice to prevent that the single strand DNA produced by high temperature denaturation is reannealed to double strand DNA. When the single strand DNA thus produced is electrophoresed, each single strand DNAs having difference on their sequences has different running shape, and therefore, produce independent peak, respectively.

Regarding to the degree of sample or analyte separation, “resolution” or “Rs” in CE is generally identified as follows:

Rs=0.59Δd/FWHM.

Wherein, Δd is the distance between the centers of two adjacent CE peaks and FWHM (full width at half maximum) is peak width at half-height, and in this case, it is assumed that the two peaks have actually same width (for example, see [Albarghouthi, Electrophoresis, 21:4096-4111 (2000)]).

As other parameters to indicate the degree of sample or analyte separation, peak width (Menchen, S., Johnson, B., Winnik, M. A., Xu, B., Electrophoresis 1996, 17, 1451-1459; and Heller, C., Electrophoresis 1999, 20, 1978-1986) and peak spacing are used. In case of the capillary electrophoresis, unlike the general gel electrophoresis, all molecules move same distance for the same time. Thus, when a peak moves slowly, broader peak width can be obtained, and therefore, the distance between adjacent peaks becomes long. In order to compensate this effect, the experimental value is corrected to indicate spatial information using the following formula.

Spatial peak width=FWHM×[300 (mm)/peak point]

(mm)(time unit)(time unit)

Spatial peak spacing=Temporal peak spacing×[300 (mm)/average peak point]

(mm)(time unit)(time unit)

The following Examples are intended to illustrate the present invention without limiting its scope.

### Preparation Example 1

### Preparation of Polymer Micelle

The PEO-PPO-PEO triblock copolymer of the present invention can be prepared by a common method. In the present invention, three different PEO-PPE-PEO triblock copolymer of i) PEO content: 71%, number-average molecular weight: 12,600 Da, ii) PEO content: 80%, number-average molecular weight: 8,400 Da, and iii) PEO content: 82.5%, number-average molecular weight: 14,600 Da were purchased from Sigma Aldrich, and used in Examples 1, 2 and 3, respectively. A conventional Gene scan gel was used in Comparative Example. Each triblock copolymer of Example 1 to 3 was dissolved in 0.7×EDTA buffer (Applied Biosystems Inc., Foster City, Calif.) to different concentrations, and viscosity of each solution at each concentration was measured and the results are listed in Table 1.

TABLE 1

| Example 1 | | Example 2 | | Example 3 | |
|---|---|---|---|---|---|
| Con- | | Con- | | Con- | |
| centration | Viscosity | centration | Viscosity | centration | Viscosity |
| (wt %) | (cP) | (wt %) | (cP) | (wt %) | (cP) |
| 9 | 300920 | 16 | 219395 | 11 | 1678600 |
| 11 | 255606.7 | 20 | 254243.3 | 13 | 1706633 |
| 13 | 1055080 | 24 | 861260 | 15 | 2996800 |
| 15 | 1955367 | | | 16 | 3049833 |

### Preparation Example 2

### Preparation of Sample for Capillary Electrophoresis Resolution Test

### <2-1> Genome DNA Isolation

Vibrio parahaemolyticus (ATCC 17802) and Vibro vulnificus (ATCC 27562) were cultured in Marine broth medium at 30° C., Vibro cholerae (ATCC 14035) was cultured in Trypticase soy broth medium at 37° C., Yersinia enterocolitica (ATCC 23715) was cultured overnight in Tryptose broth medium at 37° C.

In order to harvest the cultured cells, the culture solution was centrifuged using VS-15000CF centrifuge (Vision Scientific, South Korea) at 8,000 rpm for 3 min, the supernatant was removed, and the residue was centrifuged using Micro-12 centrifuge (Hanil Science Industrial, South Korea) at 13,000 rpm for 15 sec to remove the remained supernatant as much as possible. 16s RNA of the harvested cells was isolated using DNeasy Bolld & Tissue Kit (Qiagen, Inc., Valencia, Calif.).

Specifically, according to the manufacture's instruction of the genome DNA separation kit, the harvested cells were suspended in 50 μl pre-buffer solution containing 1 mg/ml RNase, 3 μl lysozyme solution (100 mg/ml) was added thereto followed by incubating at 37° C. for 15 min, and 250 μl G-buffer solution containing 2.1 μg/ml RNase A and 0.4 μg/ml proteinase K was added to the incubated solution followed by incubating at 65° C. for 15 min. For extra purification, 250 μl binding buffer was added to the resulting incubated solution, and the resulting solution was transferred into a column. Then, washing and elution were repeated two times to obtain pure 16s RNA.

### <2-2> PCR

In order to amplify the desired gene region from the genome DNA isolated in Preparation Example 2-1, PCR was performed using PCR premix (perfect PreMix, Takara Biomedical, Japan), MyCycler Thermal Cycler (Bio-Rad, USA) and primers synthesized at Bioneer (South Korea).

First of all, each 0.4 μl of two primers, V2 Forward 5′-GGCGAACGGGTGAGTAA-3′ (SEQ ID NO.: 1) and V2 Reverse 5′-ACTGCTGCCTCCCGTAG-3′ (SEQ ID NO.: 2), which are correspond to the variable region and the conserved region of 16S rRNA gene, respectively, and labeled at the 5′-end with benzofluorotrichlorocarboxy fluorecein (NDE) and a hexachloro derivative of fluorescein (HEX), respectively; and 0.2 μl genome DNA isolated in Preparation Example 2-1 were added to a premix containing 0.2 mM dNTP, 2 mM magnesium chloride and 1.5 units/10 μl Taq polymerase. Then, PCR was performed using a PCR machine and the following cycling conditions: 30 cycles of denaturation at 95° C. for 30 sec, annealing at 50° C. for 30 sec and extension at 72° C. for 30 sec, followed by a final extension at 72° C. for 7 min.

As shown in Table 2, all PCR products of four cell strains were of the same length of 255 bp and had relatively high homology score of 88 to 96 as a result of calculation using ClustalW2 sequence alignment software (http://www.ebi.ac.uk/Tools/clustalw2/index.html).

TABLE 2

| | Amplicon | Amplicon | Homology score between two target amplicons | | | |
|---|---|---|---|---|---|---|
| | size | molecular | V. | Y. | V. | V. |
| Strain | (bp) | weight | Parahaemolyticus | enterocolitica | vulnificus | cholerae |
| V. | 255 | 79347.4 | — | — | — | — |
| parahaemolyticus | | | | | | |
| Y. | 255 | 79317.3 | 88 | — | — | — |
| enterocolitica | | | | | | |
| V. | 255 | 79119.2 | 96 | 89 | — | — |
| vulnificus | | | | | | |
| V. | 255 | 79363.4 | 88 | 86 | 89 | — |
| cholerae | | | | | | |

### Example 1

### Resolution Test of PEO-PPE-PEO Triblock Copolymer Having PEO Content of 71% and Number-Average Molecular Weight of 12,600 Da

### <1-1> Copolymer Micelle Formation

The PEO-PPE-PEO triblock copolymer having PEO content of 71% and number-average molecular weight of 12,600 Da prepared in Preparation Example 1 was dissolved in 0.7×EDTA buffer (Applied Biosystems, Inc., Foster City, Calif.) to the concentration of 9 wt %, 11 wt %, 13 wt % and 15 wt % to have the viscosity of 10⁵ to 10⁶, which is enough to form a micelle, so as to form a micelle structure.

### <1-2> CE-SSCP Analysis for Four Samples

1.0 μl of PCR product from each of four samples prepared in Preparation Example 2 was mixed with 14 μl deionized formamide (Applied Biosystems Inc., Foster City, Calif., US). The sample mixture was denatured at 94° C. for 4 min and immediately cooled on ice.

SSCP capillary electrophoresis was performed using ABI PRISM 310 analyzer (Applied Biosystems Inc.). The capillary used in this Example was 47 cm×50 mm of Applied Biosystems Inc. 9 wt %, 11 wt %, 13 wt % and 15 wt % solution of the PEO-PPE-PEO triblock copolymer having PEO content of 71% and number-average molecular weight of 12,600 Da prepared as described above was filled in the capillary and allowed to stand overnight.

Electrophoresis condition was as follows:

Intercalation voltage: 15.0 kV,

Electrophoresis voltage: 13.0 kV,

Syringe pump time: 210 sec,

Temperature: 35° C., and Collection time: 24 min.

Laser of the analyzer detects 5′-fluorescein (HEX) phosphoamide labeled on DNA, and its signal is automatically analyzed by a DNA analysis software (Gene mapper, Applied Biosystems Inc.). X-axis data of chromatogram indicates elution time in certain unit provided from the software, and it can be converted to real time unit by applying conversion constant, 400 data value/min according to the manufacture's guideline. Elution time is indicated as scan (software unit), and peak area is automatically determined.

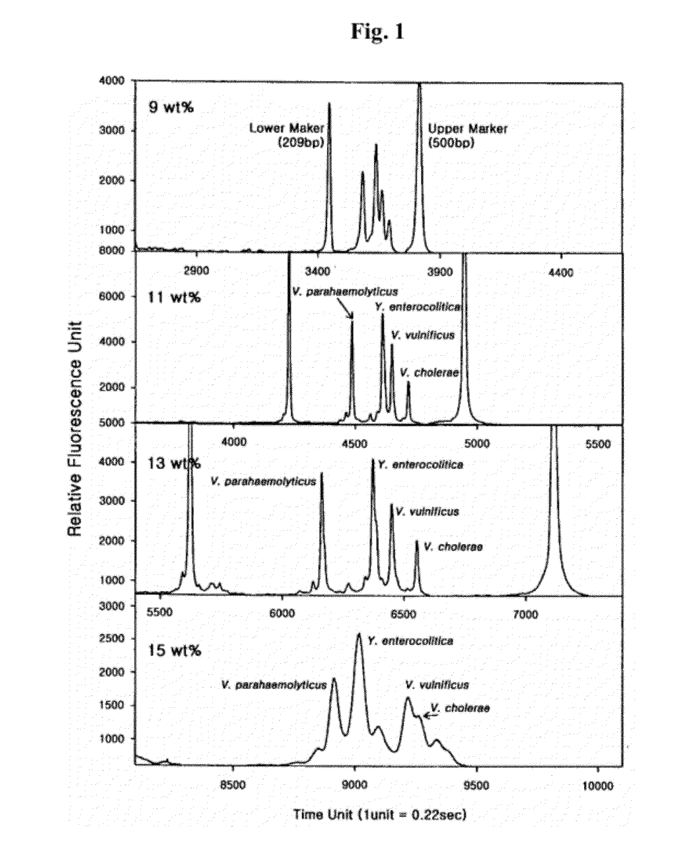

Electrophoresis results of each sample according to polymer % were shown in FIG. 1. As shown in FIG. 1, one major peak and many minor peaks were observed in all microorganisms, and this is resulted from that the single strand PCR product obtained from 16S rRNA gene of each microorganism formed a unique structure under the SSCP capillary electrophoresis condition.

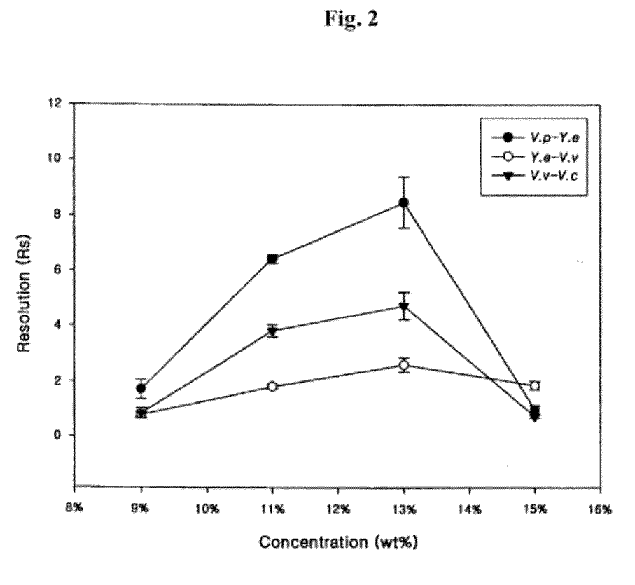

Using data shown in FIG. 1, the resolution (Rs) between the adjacent peaks was calculated as described above, and the results were shown in FIG. 2. As shown in FIG. 2, when the concentration of the triblock copolymer was 13 wt %, the highest resolution Rs was obtained, and this is consistent with the result shown in FIG. 1. As shown in FIGS. 1 and 2, the resolution Rs rapidly decreased at the concentration of 15 wt %, and this may be resulted from peak broadening caused by increased interaction between adjacent micelle and DNA according to increase of the triblock copolymer content in the matrix increases.

### Example 2

### Resolution Test of PEO-PPE-PEO Triblock Copolymer Having PEO Content of 80% and Number-Average Molecular Weight of 8,400 Da

### <2-1> Copolymer Micelle Formation

The PEO-PPE-PEO triblock copolymer having PEO content of 80% and number-average molecular weight of 8,400 Da prepared in Preparation Example 1 was dissolved in 0.7×EDTA buffer (Applied Biosystems, Inc., Foster City, Calif.) to the concentration of 16 wt %, 20 wt % and 24 wt % to have the viscosity of 10⁵ to 10⁶, which is enough to form a micelle, and allowed to stand overnight to form a micelle structure.

<2-2> Resolution Test of PEO-PPE-PEO having PEO Content of 80% and Number-Average Molecular Weight of 8,400 Da

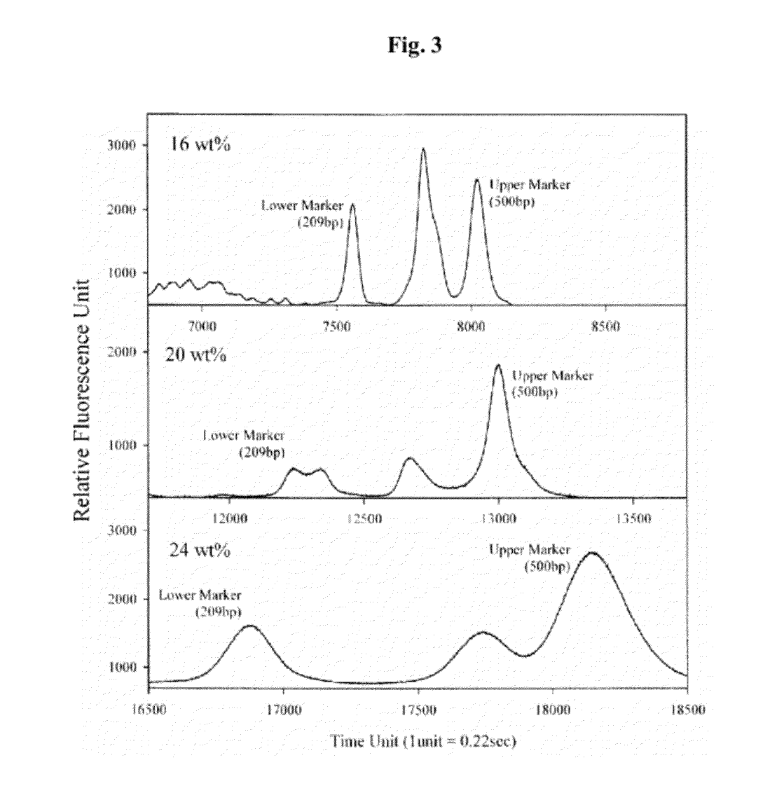

Capillary electrophoresis of each sample was performed by repeating the procedure of Example 1 except for using 16 wt %, 20 wt % and 24 wt % solutions containing the PEO-PPE-PEO triblock copolymer having PEO content of 80% and number-average molecular weight 8,400 Da in SSCP capillary electrophoresis, and the results were shown in FIG. 3.

As shown in FIG. 3, when using 16 wt %, 20 wt % and 24 wt % solutions containing the PEO-PPE-PEO having PEO content of 80% and number-average molecular weight of 8,400 Da, the resolutions were not good.

### Example 3

### Resolution Test of PEO-PPE-PEO Having PEO Content of 82.5% and Number-Average Molecular Weight of 14,600 Da

### <3-1> Copolymer Micelle Formation

The PEO-PPE-PEO triblock copolymer having PEO content of 82.5% and number-average molecular weight of 14,600 Da prepared in Preparation Example 1 was dissolved in 0.7×EDTA buffer (Applied Biosystems Inc., Foster City, Calif.) to the concentration of 11 wt %, 13 wt %, 15 wt % and 16 wt % to have the viscosity of 10⁵ to 10⁶, which is enough to form a micelle, so as to form a micelle structure.

### <3-2> CE-SSCP Analysis for Four Samples

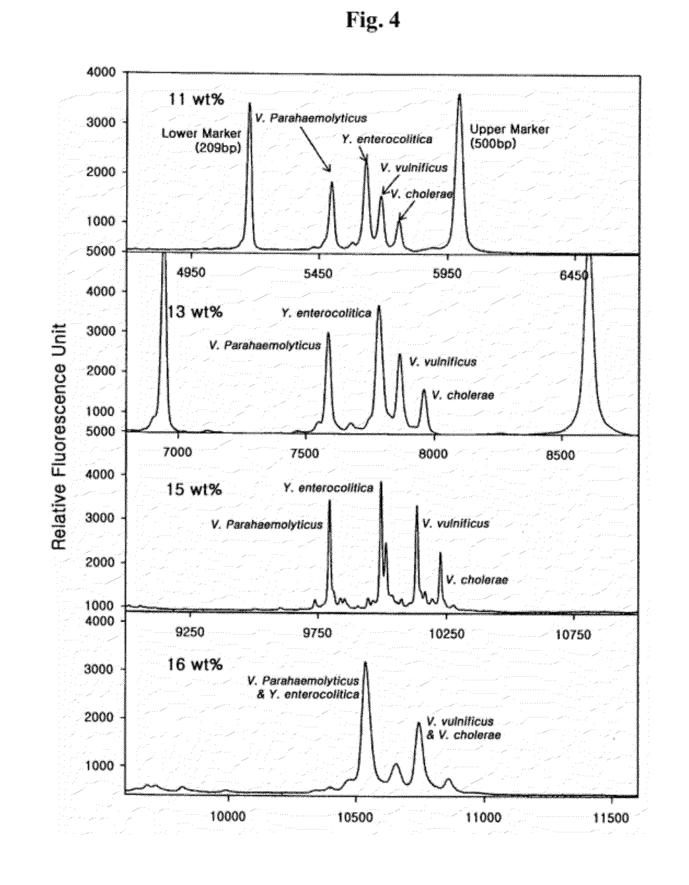

Capillary electrophoresis of each sample was performed by repeating the procedure of Example 1 except for using 11 wt %, 13 wt %, 15 wt % and 16 wt % solutions containing the PEO-PPE-PEO triblock copolymer having PEO content of 82.5% and number-average molecular weight 14,600 Da in SSCP capillary electrophoresis, and the results were shown in FIG. 4.

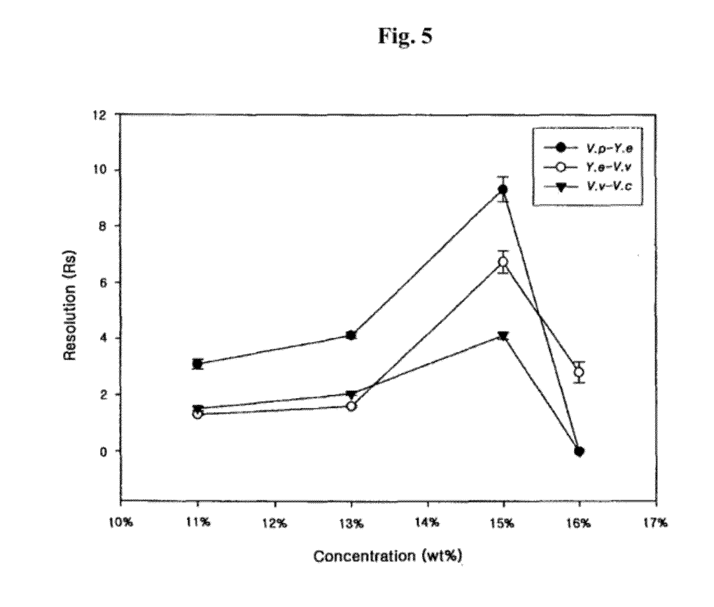

Using data shown in FIG. 4, the resolution (Rs) between the adjacent peaks was calculated as described above, and the results were shown in FIG. 5. As shown in FIG. 5, when the concentration of the triblock copolymer was 15 wt %, the highest resolution Rs was obtained, and this is consistent with the result shown in FIG. 4. As shown in FIGS. 4 and 5, the resolution Rs rapidly decreased at the concentration of 16 wt %, and this may be resulted from peak broadening caused by increased interaction between adjacent micelle and DNA according to increase of the triblock copolymer content in the matrix increases.

### Comparative Example

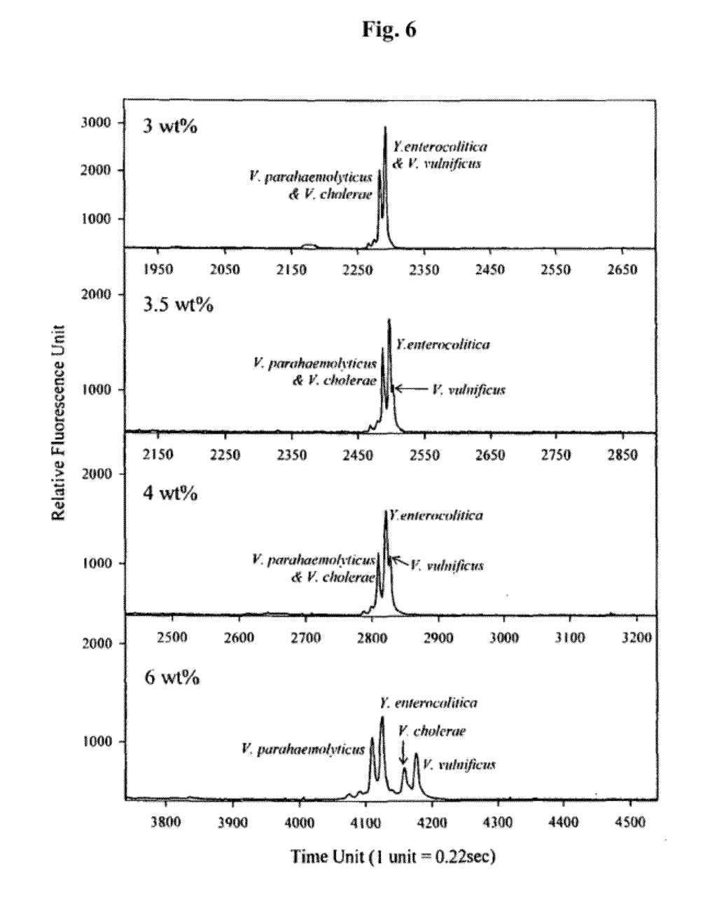

Electrophoresis was performed by repeating the procedures of Examples using ABI PRISM 310 analyzer (Applied Biosystems Inc.) for each of four samples prepared in Preparation Example 2 except for using the conventional GeneScan™ Polymer matrix dissolved to the concentration of 3 wt %, 3.5 wt %, 4 wt % and 6 wt % to have the viscosity of 10⁵ to 10⁶, which is enough to form a micelle, and the results were shown in FIG. 6.

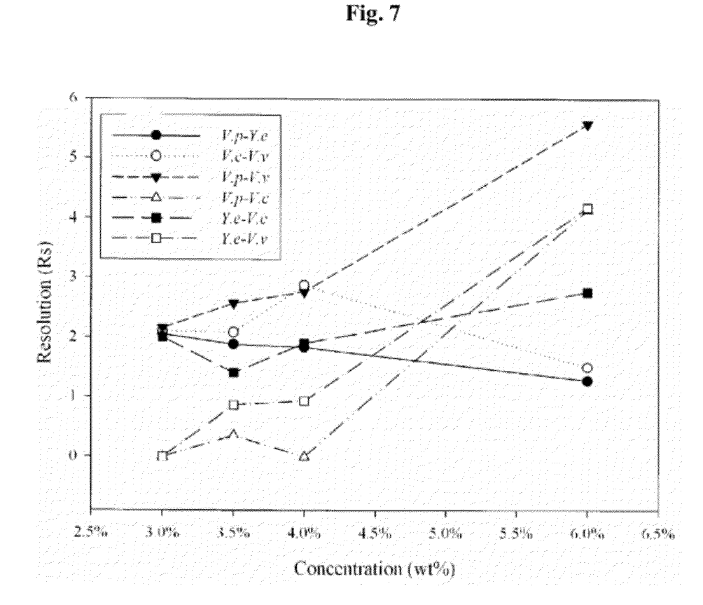

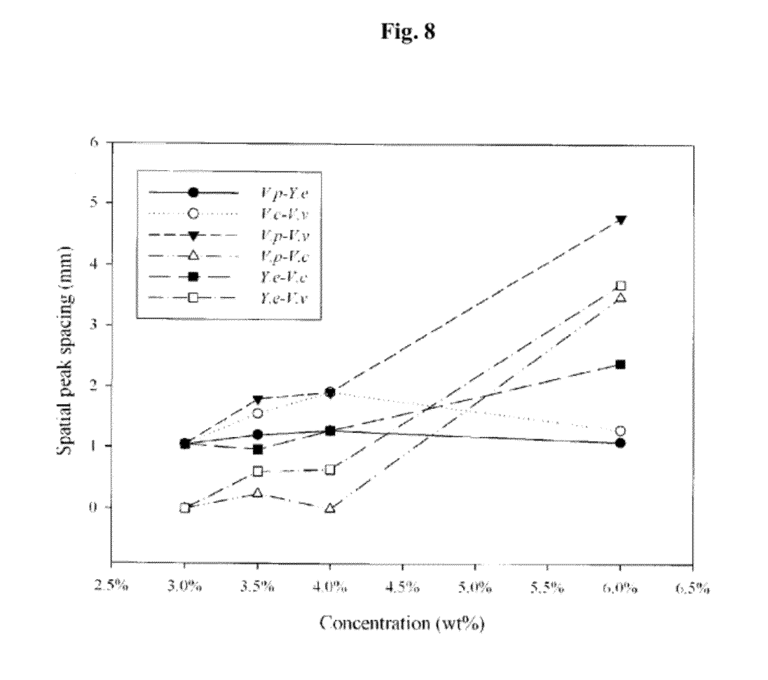

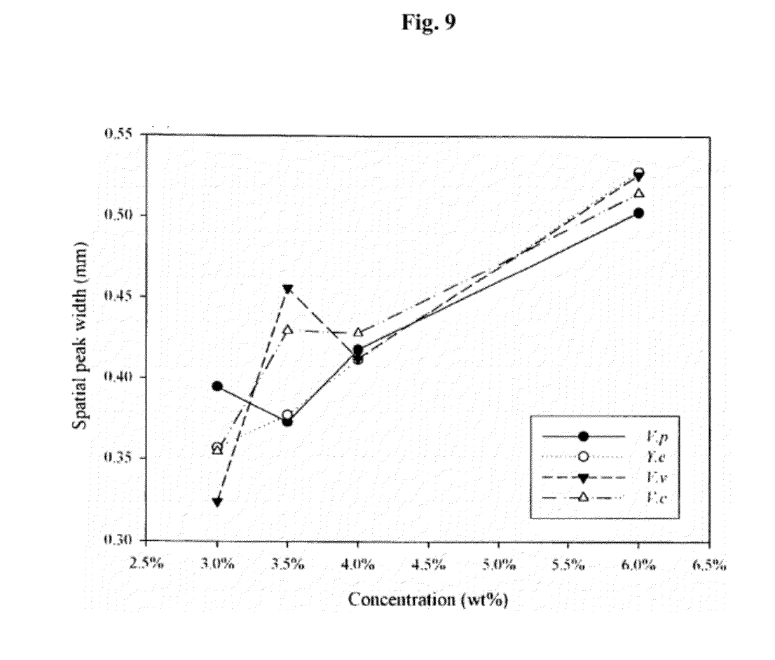

Further, in each case, the resolution (Rs), spatial peak spacing and spatial peak width were calculated and the results were shown in FIGS. 7, 8 and 9, respectively.

As shown in FIGS. 7 to 9, when using the Gene scan polymer conventionally used in capillary electrophoresis, as the polymer concentration increased from 3 wt % to 6 wt %, overall resolution increased, but the resolutions between V. parahaemolyticus and Y. enterocolitica, and V. vulnificus and V. cholerae were not largely changed. As shown in result of 6 wt % of FIG. 6, V. parahaemolyticus and Y. enterocolitica, and V. vulnificus and V. cholerae are the first and the last peak pairs. As the polymer concentration increased, the distances between V. parahaemolyticus and Y. enterocolitica, and V. vulnificus and V. cholerae increased, but because the distance between the peak pairs was not changed, the overall resolution increased, but the resolutions between V. parahaemolyticus and Y. enterocolitica, and V. vulnificus and V. cholerae were not changed.

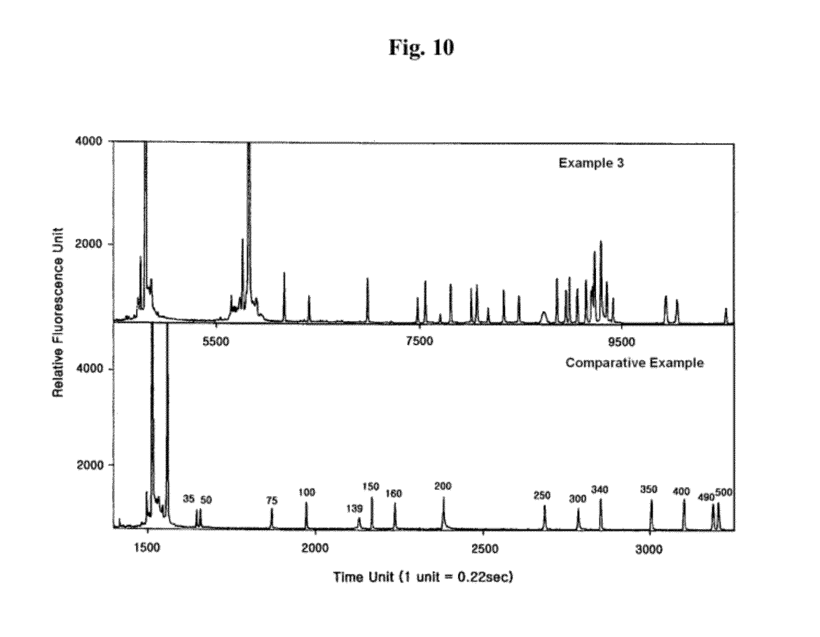

FIG. 10 is a diagram comparing results of electrophoresis according to Example 3, wherein the PEO-PPE-PEO having PEO content of 82.5% and number-average molecular weight 14,600 Da was dissolved to the concentration of 15 wt %, and Comparative Example, wherein the GeneScan polymer was dissolved to the concentration of 3.5 wt %. When the PEO-PPE-PEO copolymer of the present invention was used, the peak number was higher that that of Comparative Example, and therefore, it was confirmed that PEO-PPE-PEO copolymer of the present invention showed better resolution.

While the invention has been described with respect to the above specific embodiments, it should be recognized that various modifications and changes may be made and also fall within the scope of the invention as defined by the claims that follow.

1. Filler for analyzing capillary electrophoresis-based single strand conformation polymorphism comprising a polymer micelle, which is formed by dispersing a triblock copolymer indicated as (Hydrophilic group)-(Hydrophobic group)-(Hydrophilic group) in an aqueous medium.

2. The filler for analyzing capillary electrophoresis-based single strand conformation polymorphism of claim 1, wherein the hydrophilic group content of the triblock copolymer indicated as (Hydrophilic group)-(Hydrophobic group)-(Hydrophilic group) is 70 to 85%, and the number-average molecular weight thereof is 10,000 Da or more.

3. The filler for analyzing capillary electrophoresis-based single strand conformation polymorphism of claim 1, wherein the triblock copolymer indicated as (Hydrophilic group)-(Hydrophobic group)-(Hydrophilic group) forms the micelle by being dissolved in an aqueous medium to have the viscosity of 10⁵ to 10⁶.

4. The filler for analyzing capillary electrophoresis-based single strand conformation polymorphism of claim 1, wherein the triblock copolymer indicated as (Hydrophilic group)-(Hydrophobic group)-(Hydrophilic group) forms the micelle by being dispersed in an aqueous medium to the concentration of 11 wt % to 16 wt %.

5. The filler for analyzing capillary electrophoresis-based single strand conformation polymorphism of claim 1, wherein the triblock copolymer indicated as (Hydrophilic group)-(Hydrophobic group)-(Hydrophilic group) is a PEO-PPO-PEO triblock copolymer.

6. A method for analyzing capillary electrophoresis-based single strand conformation polymorphism, wherein a sample containing a polymer is electrophoresed in the presence of the filler for analyzing capillary electrophoresis-based single strand conformation polymorphism described in claim 1.

7. The method for analyzing capillary electrophoresis-based single strand conformation polymorphism of claim 6, wherein the polymer is a single strand.

8. The method for analyzing capillary electrophoresis-based single strand conformation polymorphism of claim 6, wherein the polymer is a gene.

9. The method for analyzing capillary electrophoresis-based single strand conformation polymorphism of claim 6, wherein the polymer contains gene variations such as SNP and CNV.
